(19) United States
(12) Patent Application Publication
(10) Pub. No.: US 2011/0278774 A1
(43) Pub. Date: Nov. 17, 2011

(54) Molding apparatus and gas compression molding process

(76) Inventors: Po-Nan Hsu, Taoyuan (TW); Kun-Sheng Liu, Taoyuan (TW); Che-Tung Wu, Taoyuan (TW); Jui-Hung Yang, Taoyuan (TW)

(21) Appl. No.: 12/848,232

(22) Filed: Aug. 2, 2010

(30) Foreign Application Priority Data
May 12, 2010 (TW) 099115085

(51) Int. Cl. B29C 51/10

(52) U.S. Cl. 264/544; 425/161

(57) ABSTRACT

A molding apparatus has a multilayered structure with multiple die cavities, in which, one or a plurality of constraining components are each employed to pull both a stripper in a molding die and an adjacent sealing die by two ends, so as to strip the molded article and confine a distance between the two dies. Furthermore, during a molding process, a plurality of plates are each disposed between two dies. The molding apparatus is allowed to be closed gradually. After the molding, the molding apparatus is allowed to be opened gradually. When the stripper within the molding die and the sealing die both moved to be held by the two ends of the constraining components respectively, the stripper in each molding die will be pulled out by the buckle ring, thereby to strip the molded articles. Accordingly, a plurality of molded articles can be obtained in one molding operation.

### BACKGROUND OF THE INVENTION

1. Field of the Invention

The present invention relates to a molding process and apparatus, and particularly to a gas-compression molding process and apparatus.

2. Description of the Prior Art

Most metal housings of electronic products are conventionally manufactured by punch press. However, in such process, the metal plate tends to be damaged at the bending of the housing profile. Air compression formation is thus developed. For example, as shown in FIG. 1, a magnesium alloy plate 1 is placed between a molding die 3 and a sealing die 4 of a die 2 and the die 2 is closed to form a cavity 5. The molding die 3 has a molding die cavity 6. A compressed air from an air compressor 8 is injected into a cavity 5 to press the magnesium alloy plate 1 forward to the molding die cavity 6 to attach the wall of the molding die 3 to form into a shape.

In Japan Patent Application Publication No. 2004-249320, a method of air compression to make magnesium alloy product is disclosed, in which a magnesium alloy plate is heated in a die cavity, pressed by air to partially form into a shape, cooled, heated again, and then pressed by air to further form into the shape. These steps are repeated several times to obtain a final product.

Furthermore, it is disclosed in Taiwan utility patent No. 342934 that after a metal plate is formed in a die, it is stripped using a lateral stripping lever to push the stripping frame upwardly, in order to push the shaped metal article out of the die cavity. However, since the stripping is carried out by lateral stripping lever, the stripping frame is subjected to a lateral force when carrying out the stripping and this may lead to losing balance.

Therefore, there is still a need for a novel method and apparatus for increasing production.

### SUMMARY OF THE INVENTION

One objective of the present invention is to provide a molding apparatus and a gas-compression molding process for improving production.

In one aspect of the present invention, a molding apparatus according to the present invention includes a first molding die, a first stripper disposed in a recess of the first molding die, a second molding die, a second stripper disposed in a recess of a first face of the second molding die, a sealing die disposed between the first molding die and the second molding die, a first constraining component and a second constraining component. The first constraining component catches a first joining block by one end portion and catches the first sealing die by another end portion. The first joining block is disposed through a first through hole located at a side wall of the first molding die to connect with the first stripper. The first through hole has a space for the first joining block to move to pull the first stripper for stripping. The second constraining component catches a second joining block by one end portion and catches the sealing die by another end portion. The second joining block is disposed through a second through hole located at a side wall of the second molding die to connect with the second stripper. The second through hole has a space for the second joining block to move to pull the second stripper for stripping. In a die opening, the first constraining component catches the first molding die and the first sealing die by its two end portions and pulls the first stripper via the first joining block, and the second constraining component catches the second molding die and the first sealing die by its two end portions and pulls the second stripper via the second joining block.

In another aspect of the present invention, a gas-compression molding process according to the present invention includes steps as follows. A plate material is placed in a molding apparatus including a molding die, a gas-inletting die and a stripper in a recess of the molding die. The molding apparatus is closed. A compressed gas is allowed to flow into the molding apparatus through the gas-inletting die for pressing the plate material into a shape. The molding apparatus is opened. When the dies are opened, a plurality of constraining components each catch the molding die and the gas-inletting die, thereby the die opening distance is confined. The constraining components each connect with the stripper by means passing through the molding die to pull the stripper upon opening the dies to strip the molded article.

Compared with conventional techniques, in the present invention, a molding apparatus has a multiple mold cavities for production by multiple plates and multiple mold cavities, which results in a plurality of molded products obtained in one molding operation. Furthermore, in preferred embodiments, the stripping mechanism can be well controlled without stocking. Accordingly, production can be improved multiply.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic view of a conventional gas-compression molding apparatus;

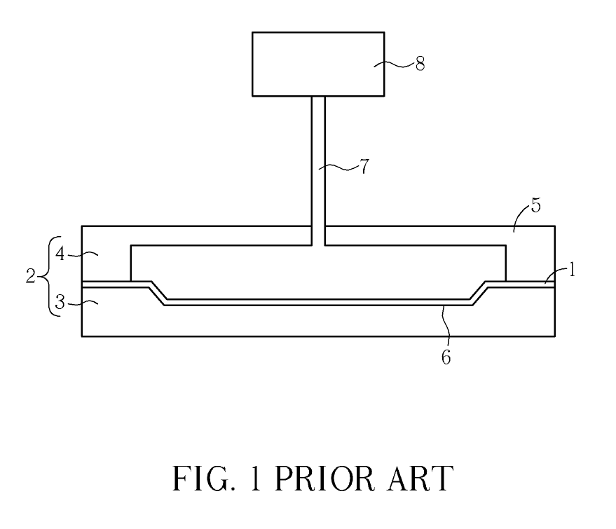

FIG. 2 is a cross-sectional view of a molding apparatus according to an embodiment of the present invention;

FIG. 3 is a side view of a molding apparatus according to an embodiment of the present invention;

FIG. 4 is a side view of a molding apparatus in a partly opened status according to an embodiment of the present invention;

FIG. 5 is a side view of a molding apparatus in a completely opened status according to an embodiment of the present invention;

FIG. 6 is a plan view of a molding die in the molding apparatus according to an embodiment of the present invention;

FIG. 7 is a cross-sectional view of a molding die taken along a line AA′ shown in FIG. 6;

FIG. 8 is a plan view of a sealing die in the molding apparatus according to an embodiment of the present invention;

FIG. 9 is a side view of a molding apparatus according to another embodiment of the present invention; and

FIG. 10 is a flow chart illustrating main steps of a gas-compression molding process according to an embodiment of the present invention.

### DETAILED DESCRIPTION

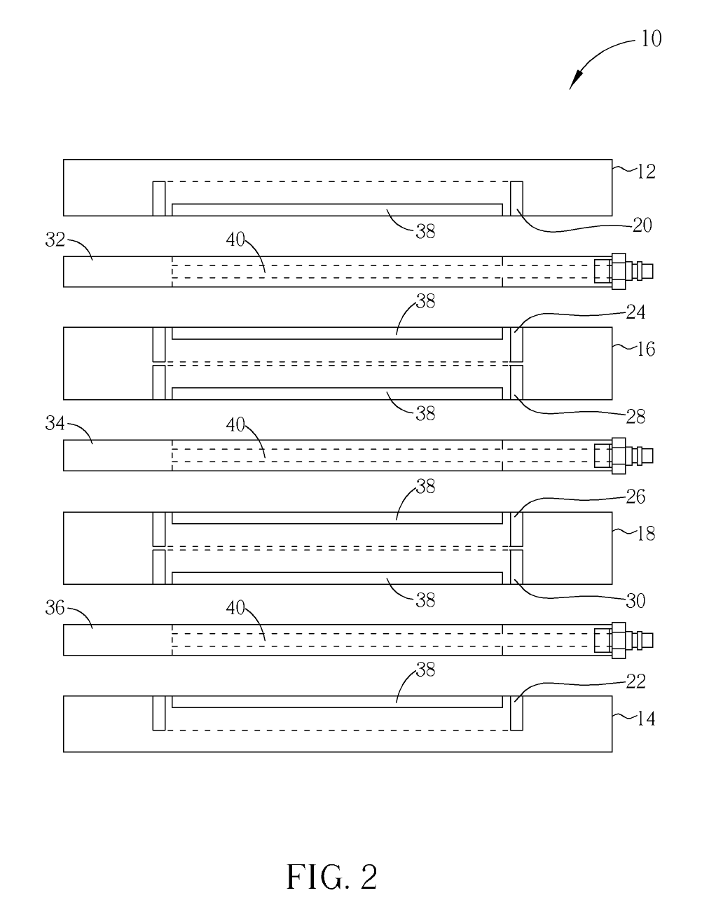

FIG. 2 is a schematic cross-sectional view of a molding apparatus for illustrating the present invention. The molding apparatus 10 includes molding dies 12, 14, 16 and 18, strippers 20 and 22 respectively disposed in recesses of the molding dies 12 and 14, strippers 24 and 26 respectively disposed in recesses of the molding dies 16 and 18 at one face, strippers 28 and 30 respectively disposed in recesses of the molding dies 16 and 18 at another face, sealing dies 32, 34 and 36 respectively disposed between the molding die 12 and the molding die 16, between the molding die 16 and the molding die 18, and between the molding die 18 and the molding die 14.

The molding dies 12 and 14 may each include a die cavity 38 at one face (or referred to as “side”), and the molding dies 16 and 18 may each include two die cavities 38 at two faces. The cavity per se or a die core when which is further included may have a shape as a desired shape for the working article to be shaped into, no matter it is a convex die or a concave die. A vacuum port may be further connected to the die cavity for air evacuation to help press-molding.

When the molding apparatus 10 is used for the gas-compression molding process, the sealing dies 32, 34, and 36 each may further include a gas-inletting channel 40, and thus the sealing die may be also referred to as a gas-inletting die. Under die closure, the sealing die and each of two adjacent molding dies at its two sides form a cavity. The gas-inletting channel may be allowed to connect with both of these two cavities. The gas-inletting channels of different gas-inletting dies may be connected with each other or each independent. The same or different compressed gas sources may be utilized. The injection of gas can be controlled by a gas-inletting valve.

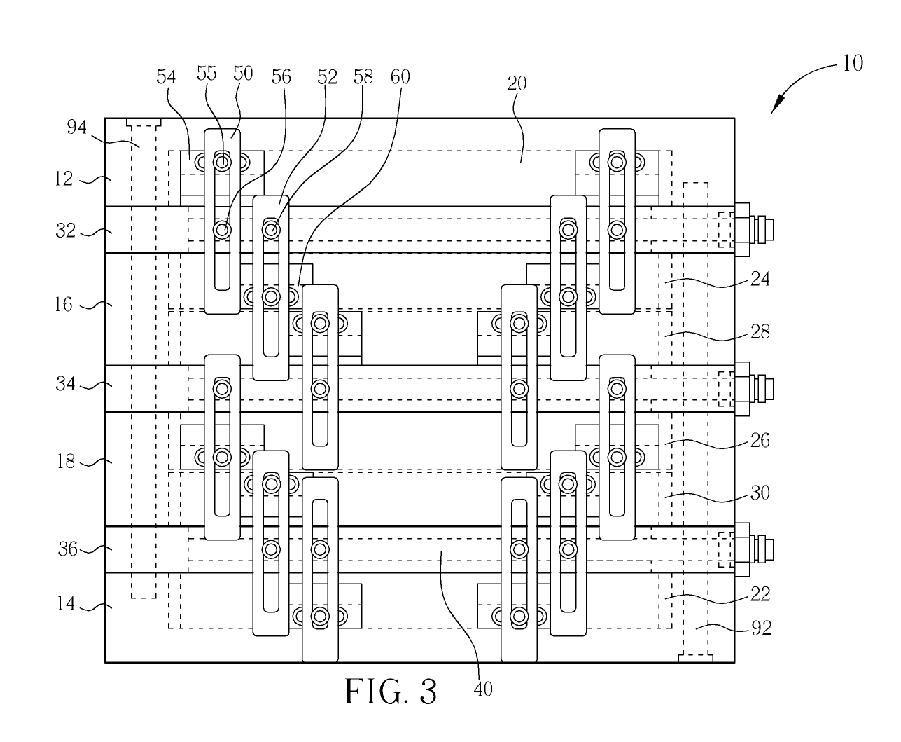

FIG. 2 only illustrates some components and other components are omitted, for clearly indicating these components first. FIG. 3 further shows a side view of a molding apparatus under a die-closure status according to an embodiment of the present invention. The sealing die 32 and the stripper 20 in the molding die 12 adjacent to one side of the sealing die 32 are connected and thus confined through a rectangle ring 50 serving as a constraining component. The sealing die 32 and a stripper 24 in the molding die 16 adjacent to another side of the sealing die 32 are connected and confined through a rectangle ring 52. Likewise, sealing dies 34 and 36 each are connected with the stripper in the adjacent molding die through a rectangle ring and confined by the rectangle ring.

Taking the molding die 12, sealing die 32, and molding die 16 as an example, the rectangle ring 50 catches a joining block 54, and this can be accomplished through for example disposing a bolt 55 on the molding die 12, while the bolt 55 is still allowed to glide along a hollow portion circumscribed by the rectangle ring 50. The rectangle ring 50 catches the sealing die 32 by another end portion, and this can be accomplished through for example disposing a bolt 56 on the sealing die 32, while the bolt 56 is still allowed to glide along a hollow portion circumscribed by the rectangle ring 50. The joining block 54 is disposed through a through hole located at a side wall of the molding die 12 to connect with the stripper 20. The through hole has a space for the joining block 54 to move. When the joining block 54 is pulled, the stripper 20 connected to the joining block 54 is also pulled, so as to accomplish stripping. The length of the rectangle ring 50 is greater than the distance between the bolt 55 and the bolt 56 under the die closure status. Accordingly, in the step of opening the molding apparatus, the distance between every two adjacent dies is gradually increased. When the bolts 55 and 56 both reach the two ends of the rectangle ring respectively, the bolt and the end will block each other. Then, the joining block 54 and the stripper 20 together continue moving. The through hole has a sufficient space for the joining block 54 to move. As shown in FIG. 3, the molding die 12 is at the top of the molding apparatus 10. When the joining block 54 is pulled downward, the stripper 20 is also pulled down for a distance by the joining block 54, such that the molded article can be pushed by the stripper 20 and accordingly stripped from the molding die. The movement can be carried out until the joining block 54 reaches the bottom of the through hole. The molding die 12 and the sealing die 32 are caught by the rectangle ring 50; thereby the die distance under die opening status is confined. The sealing die 32 is hung under the molding die 12 by the rectangle ring 50.

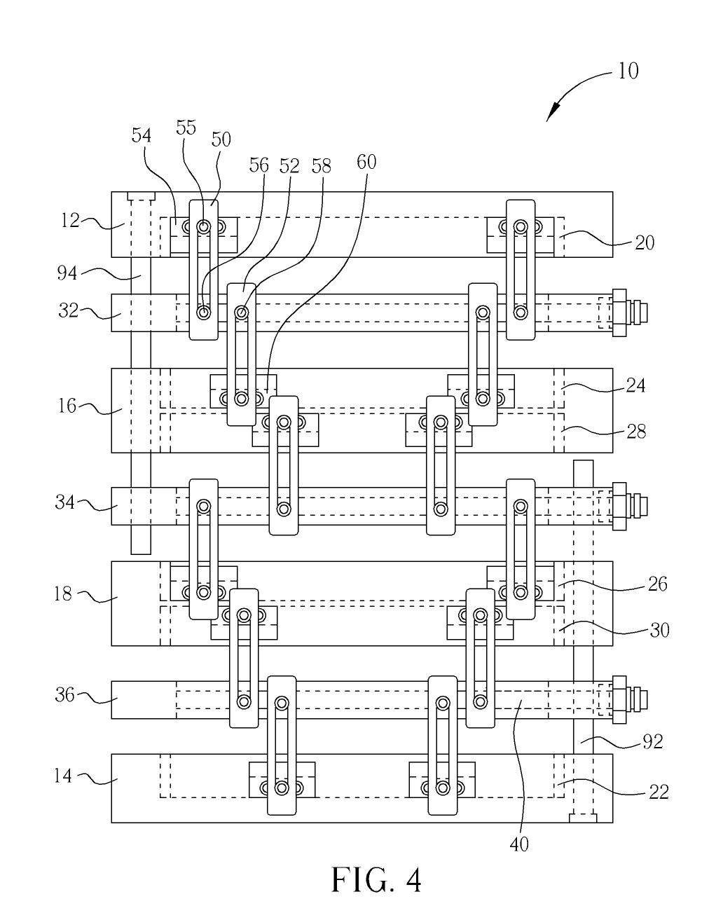

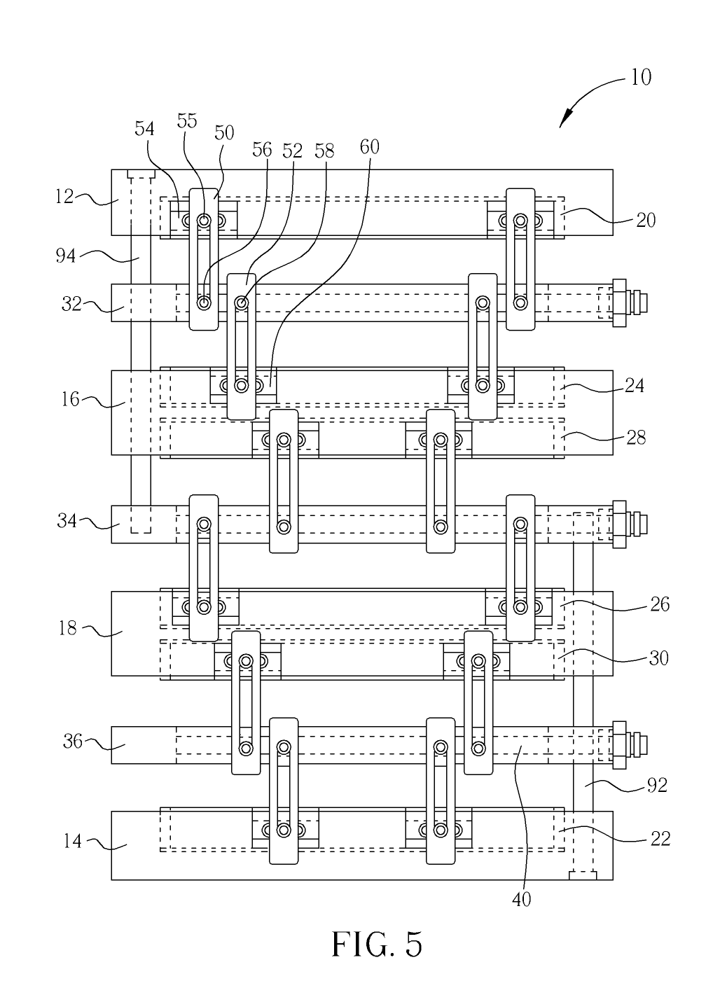

Likewise, the rectangle ring 52 catches a sealing die 32 by one end portion and catches the joining block 60 by another end portion to constrain the sealing die 32 and the molding die 16. Other rectangle rings serve similarly. Accordingly, to open the dies is to pull the dies to separate them. The number and the position of the rectangle rings are not particularly limited. The rectangle rings are preferably located at positions not interfering with die closure, and, in the case of for example gas-compression molding, not interfering with air tightness. The location may be for example at external side of each die. The rectangle rings may be disposed at locations and in a number in considering not affecting each other and the balance upon die opening. For example, each stripper may be equipped with for example one, two, three or four rectangle rings in order to smoothly pull the connected stripper during die opening. Furthermore, it is preferred that no rectangle ring is disposed on a whole side of the dies, so as to leave sufficient room for operators to take out molded articles. FIG. 4 shows a status that each die has been pulled to be apart from each other, while the strippers are not pulled to move yet. FIG. 5 shows a status that all dies are pulled to be apart from each other and all the strippers are pulled off the molding dies.

The constraining component is not limited to the rectangle ring having the shape as shown in the drawing. It may be for example a long-shape ring or loop, a chain, and the like, as long as the separation distance between two caught dies can be confined. The two dies to be constrained are preferably two adjacent dies, i.e. a molding die and a sealing die; while, two non-adjacent dies also can be constrained. According to a spirit of the present invention, the constraining component is usable as long as its one end can move a stripper in a recess of a molding die and simultaneously be kept by the molding die and another end can hold other die, so as to allow an upper die to hang a lower die (when the dies are disposed vertically), or to allow a die at one side to pull a die at another side (when the dies are disposed horizontally), and the separation distance of the dies is appropriate for use or desired. Furthermore, when the dies are disposed vertically, the constraining components located at upper dies may need to bear the total weight of the lower dies. For this, more constraining components may be further disposed at further upper dies or hung under a higher stronger stage, to share the weight.

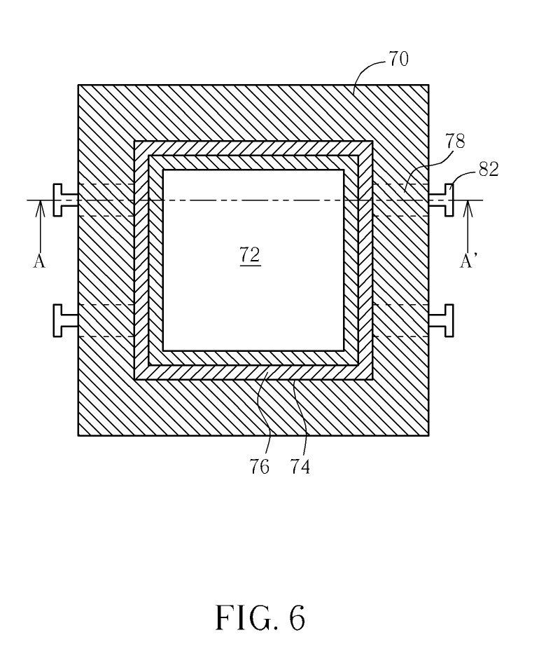

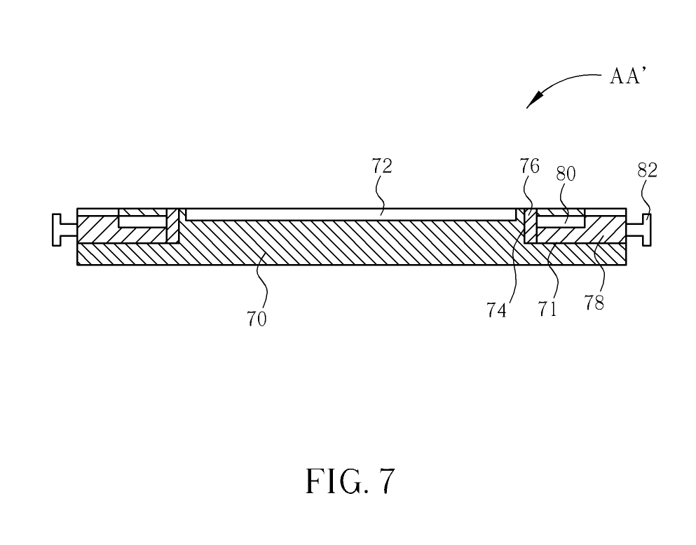

FIG. 6 shows a plan view of an embodiment of a molding die. FIG. 7 is a cross-sectional view of a molding die taken along a line AA′ shown in FIG. 6. Each die shown in FIG. 2 mentioned above may also have such type of structure. The molding die 70 has a die cavity 72, and a stripper is disposed in the recess 74. In this embodiment, the stripper is in a frame shape and to be referred as a stripping frame 76. The side wall of the molding die 70 has a through hole 71. A joining block 78 is disposed in the through hole 71 to connect to the stripping frame 76. The through hole 71 has a sufficient space 80 for the joining block 78 to move. A bolt 82 may be disposed for the constraining component to catch. As shown in FIG. 6, four bolts disposed at two sides of the molding die can provide for four constraining components to catch.

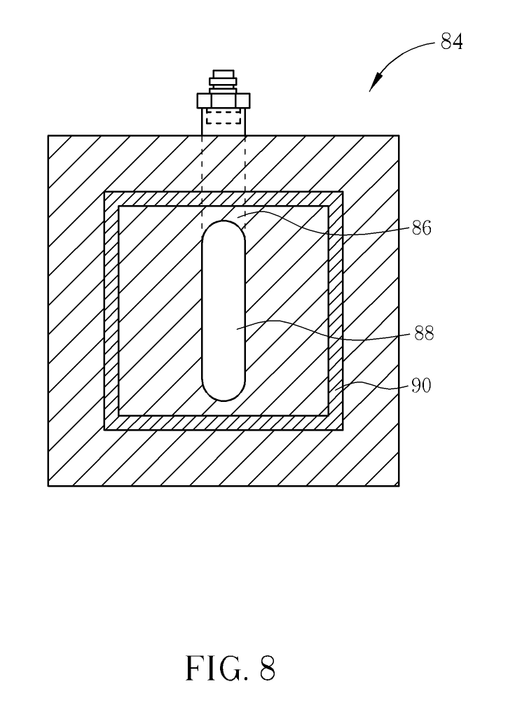

FIG. 8 shows a plan view of a sealing die. The sealing die 84 has a gas-inletting channel 86. There is an opening 88 in the middle of the sealing die 84. Under a die closure status, the gas-inletting channel 86 is connected with an adjacent die cavity. A sealing gasket 90 may be disposed on each of two sides of the sealing die 84 to favor air tightness during die closure.

Material for the molding die, stripper, constraining component, bolt and the like is chosen as desired or required. When used in high pressure gas-compression formation, for example, steel resistant to high temperature, high pressure, and corrosion may be utilized.

The molding apparatus according to the present invention may optionally include a heating device for heating plate materials placed within the molding apparatus. This may facilitate the molding process. The heating device may be combined with the external surface of the outmost molding dies of the molding apparatus for heating the molding dies, and in turn to heat the plate materials within the cavities. The heating device may be for example a heating coil or a heating plate, but not limited thereto.

Furthermore, as shown in FIGS. 3, 4 and 5, the molding apparatus according to the present invention may further include at least a guiding pillar 92. The guiding pillar 92 penetrates each molding die and sealing die for guiding. There may be for example one, two, three, or four guiding pillars, and preferably four guiding pillars. In another embodiment, the molding apparatus may include two groups of guiding pillars altogether penetrate all the dies in opposite directions. Each group may include at least a guiding pillar, such as one, two, three, or four guiding pillars, but the number is not particularly limited, as long as the disposition and the guiding function is good. The first group of guiding pillars penetrate each die from the top one downwardly, i.e. they penetrate the top molding die 12, some sealing dies, and some middle molding dies, for example, as the guiding pillar 92 does. The second group of guiding pillars penetrate each die from the bottom one upwardly, i.e. they penetrate the bottom molding die 14, and the other sealing dies and molding dies not penetrated by the first group of guiding pillars as demonstrated under a complete die opening status, for example, as the guiding pillar 94 does. Preferably, the first group of guiding pillars and the second group of guiding pillars are allowed to penetrate at least a same sealing die or molding die, to make the guiding function more stable. In the case that the die cavity needs airtight properties, the guiding pillars are preferably located outside the die cavity, for example, between the stripper and the edge of each die. It is more preferred not to interfere with process operations, such as taking out the molded articles.

The molding apparatus according to the present invention may further include a power driving device to move the two outmost molding dies forward to or apart from each other for carrying out die closure and die opening. For example, the molding dies 12 and 14 are fixed on two stages of the power driving device. The two stages are controlled to move closer or farther by the power driving device, in order to control the molding apparatus to open or to close. For example, one stage may stay in a position, and the other stage may bring the molding dies up or down by moving or pushing an outmost die to carryout the die opening or closure. Upon this, the aforesaid guiding pillars may preferably have a length shorter than a total height of the dies under a die closure status. If the guiding pillars have a surplus length, voids may be needed in the stages for accommodating the guiding pillars.

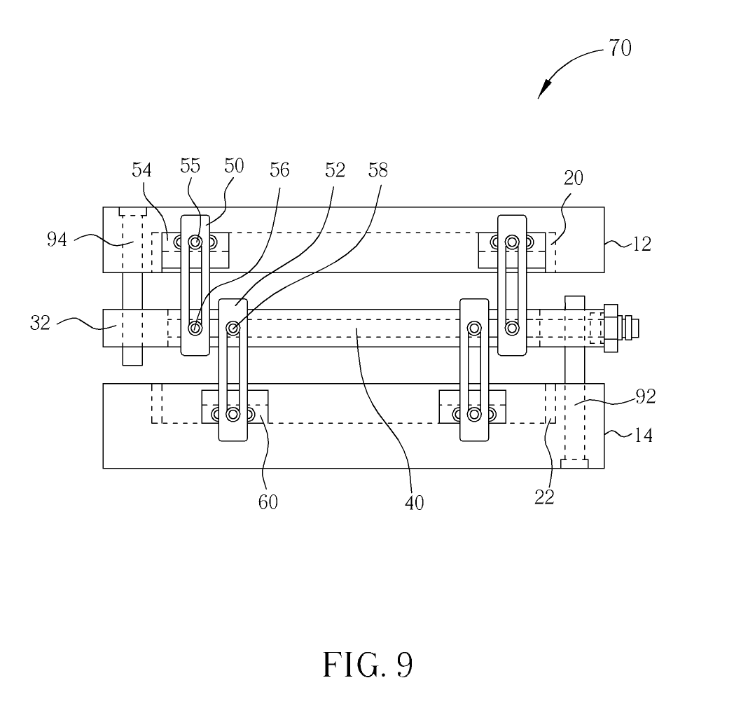

FIG. 9 illustrates a molding apparatus according to another embodiment of the present invention. The molding apparatus 70 only includes three dies, i.e. a molding die 12, a sealing die 32 and a molding die 14. A stripper 20 is disposed in a recess of the molding die 12, and a stripper 22 is disposed in a recess of the molding die 14. The rectangle ring 50 catches a joining block 54 by means of setting a bolt 55. The joining block 54 is disposed through a through hole located at a side wall of the molding die 12 to connect with the stripper 20. The through hole has a space for the joining block 54 to move to pull the stripper 20 for stripping. The rectangle ring 50 catches the sealing die 32 by another end portion by means of setting a bolt 56, for example. The rectangle ring 52 catches a sealing die 32 by means of setting a bolt 58. The rectangle ring 52 catches a joining block 60. The joining block 60 is disposed through a through hole located at a side wall of the molding die 14 to connect with the stripper 22. The through hole has a space for the joining block 60 to move to pull the stripper 22 for stripping. Under a die closure status, the molding die 12 with the sealing die 32 will together form a cavity, and the sealing die 32 ad the molding die 14 will together form a cavity. Under die opening, the molding die 12 and the sealing die 32 will be apart from each other and the molding die 12 and the sealing die 32 will be constrained by the rectangle ring 50; the molding die 14 and the sealing die 32 will be apart from each other and the molding die 14 and the sealing die 32 will be constrained by the rectangle ring 52. The molding apparatus 70 may further include guiding pillars, such as 92 and 94, as the aforesaid. Other possible variations or modifications may be similar with the aforesaid and are not described herein for conciseness.

It may be noted that when it is desired to increase the dies of the molding apparatus, the molding die 14 may be for example to be allowed to have a die cavity at both sides and have a stripper disposed therein, and a sealing die and one more molding die may be added to the stack of dies. The embodiment of increasing dies for the molding apparatus may be referred to FIGS. 3-5. According to a spirit of the present invention, in the molding apparatus of the present invention, the number of the dies is not particularly limited and it may depend on the properties of strength, weight, size, and the like of each component. Furthermore, the molding apparatus according to the present invention is not limited to vertical disposition, and any orientation for the disposition, such as horizontal disposition, is possible under a suitable guiding means.

In another aspect of the present invention, referring to FIGS. 3-5, and 10, a gas-compression molding process according to the present invention includes steps as follows. In Step 101, a plurality of plate materials are placed in an aforesaid molding apparatus and the molding apparatus is closed. There is a plate material between every two adjacent dies. The edge of the plate material extends to the outside of the cavity for favoring air tightness. Each die is guided by a plurality of guiding pillars, as mentioned above. In Step 103, compressed gas is injected into the cavity to press the plate material into a desired shape. All gas-inletting channels may be connected with each other and the compressed gas is supplied by a gas compressor. Alternatively, the compressed gas can be injected to each gas-inletting channel separately. A high temperature compressed gas may be supplied. Alternatively, the plate material may be heated in advance, and then the press-formation is carried out when the plate material is hot. The temperature may be between room temperature and 520° C. The pressure may be between a normal pressure and 150 kg/cm². These may depend on material and design of the tool and the plate material without particular limitation. After molding, in Step 105, the dies are pulled apart for die opening. In die opening, strippers are pulled (may be one after another) off the dies by constraining components. For example, the molding die 12 and the sealing die 16 (it may be a gas-inletting die in gas-compression formation) are caught by a plurality of rectangle ring 50 to confine the die opening distance. The rectangle ring 50 connects with the stripper 20 by a means passing through the molding die 12, to pull the stripper 20 upon opening the dies to strip the molded article.

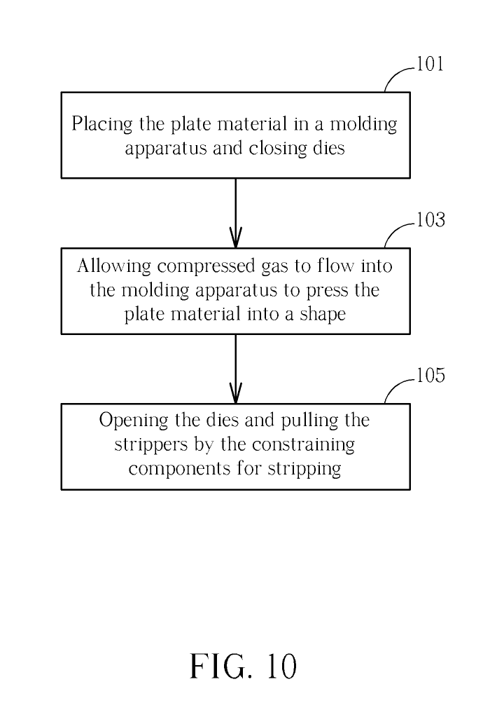

Referring to FIGS. 9 and 10, when the molding apparatus having an aforesaid three-die structure is employed, the gas-compression molding process according to the present invention includes steps as follows. As in Step 101, two plate materials are placed in an aforesaid molding apparatus respectively and the molding apparatus is closed. There is a plate material between a first molding die and a sealing die and between a sealing die and the second molding die. The edge of the plate material extends to the outside of the cavity. Each die is guided by a plurality of guiding pillars, as mentioned above. As in Step 103, compressed gas is injected into each cavity to press the plate material against the molding die to form into a desired shape. Gas pressure and temperature may be as mentioned above. After molding, as in Step 105, the dies are pulled apart for die opening. In die opening, strippers are pulled off the dies by constraining components to strip the molded articles.

The plate material may be any material suitable to gas-compression formation. For example it may be metal plate, and preferably super-plastic metal plate, such as magnesium alloy.

In the present invention, constraining components such as rectangle rings are utilized to catch strippers in molding dies and adjacent sealing dies (if in a vertical disposition, the molding apparatus is suspended) and to confine the die opening distance. The plate materials are placed in the dies respectively, and then the dies can be closed by for example making a bottom stage to move up to pushup the dies, one by one from the bottom die to the upper dies, to move upward, so as to close the dies. After gas-compression formation, the bottom stage moves down to allow the dies to move down, so as to gradually open the dies. For example, when all of the bolts at the strippers in the molding dies reach one ends of the rectangle rings, and all of the bolts at the sealing dies reach another ends of the rectangle rings, the bottom stage continues moving down, such that the strippers will be pulled off the molding die. Accordingly, by utilizing the molding apparatus according to the present invention, a production mode of multiple plates in multiple cavities can be attained. Without using additional molding apparatus, a plurality of plate materials can be molded in the plurality of cavities in one operation, and thus the production can be multiplied.

Those skilled in the art will readily observe that numerous modifications and alterations of the device and method may be made while retaining the teachings of the invention.

What is claimed is:

1. A molding apparatus, comprising:
a first molding die;
a first stripper disposed in a recess of the first molding die;
a second molding die;
a second stripper disposed in a recess of a first face of the second molding die;
a first sealing die disposed between the first molding die and the second molding die;
a first constraining component for catching a first joining block by one end portion and catching the first sealing die by another end portion, wherein, the first joining block is disposed through a first through hole located at a side wall of the first molding die to connect with the first stripper, and the first through hole has a space for the first joining block to move to pull the first stripper for stripping; and
a second constraining component for catching a second joining block by one end portion and catching the first sealing die by another end portion, wherein, the second joining block is disposed through a second through hole located at a side wall of the second molding die to connect with the second stripper, and the second through hole has a space for the second joining block to move to pull the second stripper for stripping,
wherein, during a die opening, the first constraining component catches the first molding die and the first sealing die by its two end portions and pulls the first stripper via the first joining block, and the second constraining component catches the second molding die and the first sealing die by its two end portions and pulls the second stripper via the second joining block.

2. The molding apparatus of claim 1, wherein the first sealing die comprises a gas-inletting channel.

3. The molding apparatus of claim 1, further comprising one, two or three constraining components having a mechanism the same as the first constraining component, for smoothly pulling the first stripper for stripping.

4. The molding apparatus of claim 1, further comprising one, two or three constraining components having a mechanism the same as the second constraining component, for smoothly pulling the second stripper for stripping.

5. The molding apparatus of claim 2, further comprising one, two or three constraining components having a mechanism the same as the first constraining component, for smoothly pulling the first stripper for stripping.

6. The molding apparatus of claim 2, further comprising one, two or three constraining components having a mechanism the same as the second constraining component, for smoothly pulling the second stripper for stripping.

7. The molding apparatus of claim 1, further comprising a heating device for heating a plate material placed within the molding apparatus.

8. The molding apparatus of claim 1, further comprising a guiding pillar penetrating each of the molding dies and the sealing dies for guiding.

9. The molding apparatus of claim 1, further comprising a plurality of guiding pillars each penetrating each of the molding dies and the sealing dies for guiding.

10. The molding apparatus of claim 1, further comprising a first guiding pillar and a second guiding pillar for guiding, wherein, the first guiding pillar penetrates the first molding die and the first sealing die, and the second guiding pillar penetrates the second molding die and the first sealing die.

11. The molding apparatus of claim 1, further comprising a plurality of first guiding pillars and a plurality of second guiding pillars for guiding, wherein, each of the first guiding pillars penetrates the first molding die and the first sealing die, and each of the second guiding pillars penetrates the second molding die and the first sealing die.

12. The molding apparatus of claim 1, further comprising a sealing gasket disposed on two sides of the first sealing die for air tightness during die closure.

13. The molding apparatus of claim 1, further comprising:
a third stripper disposed in a recess of a second face of the second molding die;
a third molding die;
a fourth stripper disposed in a recess of a first face of the third molding die;
a second sealing die disposed between the second molding die and the third molding die;
a third constraining component for catching a third joining block by one end portion and catching the second sealing die by another end portion, wherein, the third joining block is disposed through a third through hole located at a side wall of the second molding die to connect with the third stripper, and the third through hole has a space for the third joining block to move to pull the third stripper for stripping; and
a fourth constraining component for catching a fourth joining block by one end portion and catching the first sealing die or the second sealing die by another end portion, wherein, the fourth joining block is disposed through a fourth through hole located at a side wall of the third molding die to connect with the fourth stripper, and the fourth through hole has a space for the fourth joining block to move to pull the fourth stripper for stripping,
wherein, during the die opening, the third constraining component catches the second molding die and the second sealing die by its two end portions and pulls the third stripper via the third joining block, and the fourth constraining component catches the third molding die and the first sealing die or the second sealing die by its two end portions and pulls the fourth stripper via the fourth joining block.

14. The molding apparatus of claim 13, wherein the second sealing die comprises a gas-inletting channel.

15. The molding apparatus of claim 13, further comprising one, two or three constraining components having a mechanism the same as the first constraining component or the fourth constraining component, for smoothly pulling the third stripper or the fourth stripper for stripping.

16. The molding apparatus of claim 14, further comprising one, two or three constraining components having a mechanism the same as the first constraining component or the fourth constraining component, for smoothly pulling the third stripper or the fourth stripper for stripping.

17. The molding apparatus of claim 13, further comprising a heating device for heating a plate material placed within the molding apparatus.

18. The molding apparatus of claim 13, further comprising a guiding pillar penetrating each of the molding dies and the sealing dies for guiding.

19. The molding apparatus of claim 13, further comprising a first guiding pillar and a second guiding pillar for guiding, wherein the first guiding pillar and the second guiding pillar in opposite directions altogether penetrate the first molding die, the first sealing die, the second molding die, the second sealing die and the third molding dies.

20. The molding apparatus of claim 19, wherein the first guiding pillar and the second guiding pillar both penetrate a same one of the sealing dies or a same one of the molding dies.

21. The molding apparatus of claim 13, further comprising a sealing gasket disposed on two sides of the second sealing die for air tightness during die closure.

22. A gas-compression molding process comprising:
placing a plate material in a molding apparatus comprising a molding die, a gas-inletting die and a stripper in a recess of the molding die;
closing the molding apparatus;
allowing a compressed gas to flow into the molding apparatus through the gas-inletting die for pressing the plate material into a shape; and
opening the molding apparatus, wherein, a plurality of constraining components each catch the molding die and the gas-inletting die to confine a die opening distance, and the constraining components each connect with the stripper by a means passing through the molding die to pull the stripper upon die opening to strip the molded article.

23. A method of claim 22, wherein the compressed gas comprises a high-temperature compressed gas.

24. A method of claim 22, further comprising a step of heating the plate material before the plate material is molded.
